(19) United States
(12) Patent Application Publication
(10) Pub. No.: US 2026/0025641 A1
(43) Pub. Date: Jan. 22, 2026

(54) CELL RESELECTION METHOD FOR MBS SERVICE CONTINUITY, METHOD FOR PROVIDING MBS SERVICE CONTINUITY, AND RELATED DEVICES

(71) Applicant: PURPLEVINE INNOVATION COMPANY LIMITED, Hongkong (HK)

(72) Inventor: Chiu-Wen CHEN, Hongkong (HK)

(73) Assignee: PURPLEVINE INNOVATION COMPANY LIMITED, Hongkong (HK)

(21) Appl. No.: 18/996,983

(22) PCT Filed: Jul. 21, 2023
(86) PCT No.: PCT/CN2023/108696

§ 371 Date: Jan. 18, 2025

Related U.S. Application Data
(60) Provisional application No. 63/369,031, filed on Jul. 21, 2022.

(30) Foreign Application Priority Data
Jul. 21, 2022 (US) 63369031

(51) Int. Cl. H04W 4/06; H04W 74/0833

(52) U.S. Cl. CPC H04W 4/06; H04W 74/0833

(57) ABSTRACT

A cell reselection method for multicast and/or broadcast service (MBS) service continuity and related devices are provided. The method, performed by a user equipment (UE), includes staying on a first cell for MBS data reception based on an MBS configuration in a power saving state; receiving a signaling from at least one of the first cell or at least one neighboring cell for the power saving UE to prioritize cells for cell reselection, wherein an MBS indication comprised in the signaling is configured to identify whether an MBS session of an associated cell is activated; and selecting a second cell from the at least one neighboring cell based on the MBS indication, and changing from the first cell to the second cell to camp on for the MBS data reception. With this method, MBS service continuity is achieved during the change of serving cell.

### TECHNICAL FIELD

The present disclosure relates to the field of wireless communications, and more particularly, to a cell reselection method for multicast and/or broadcast service (MBS) service continuity, a method for providing MBS service continuity, and related devices.

### BACKGROUND ART

Communication systems and networks have developed towards being a broadband and mobile system. In cellular wireless communication systems developed by the Third Generation Partnership Project (3GPP), user equipment (UE) is connected by a wireless link to a radio access network (RAN). The RAN includes a set of base stations (BSs) which provide wireless links to the UEs located in cells covered by the base station, and an interface to a core network (CN) which provides overall network control. As will be appreciated, the RAN and CN each conduct respective functions in relation to the overall network. The 3GPP has developed the so-called Long Term Evolution (LTE) system, namely, an Evolved Universal Mobile Telecommunication System Territorial Radio Access Network (E-UTRAN), for a mobile access network where one or more macro-cells are supported by a base station known as an eNodeB or eNB (evolved NodeB). More recently, evolved from LTE, the so-called 5G or New radio (NR) systems where one or more cells are supported by a base station known as a gNB.

In LTE, the network may order the UE to get into an RRC_IDLE state if the UE has no activity for a while. This is done to reduce UE's power consumption. The UE needs to transit from the RRC_IDLE state to an RRC_CONNECTED state whenever the UE needs to perform some activity. Since small amounts of data have to be sent very frequently in current mobile communication applications, frequent Idle-Connected-Idle transitions increase network signaling load and latency. Therefore, 5G NR has defined a new state called RRC_INACTIVE to reduce network signaling load and latency involved in transiting to RRC_CONNECTED state. In NR, a UE is in RRC_CONNECTED when an RRC connection has been established or in RRC_INACTIVE when the RRC connection is suspended. If this is not the case, the UE is in RRC_IDLE state, that is, no RRC connection is established. The RRC_INACTIVE and RRC_IDLE states may be referred to as a power saving state. More specifically, in RRC_INACTIVE state, the UE Access Stratum (AS) context is stored at both UE and network sides so that the core network connection is maintained (i.e., the UE keeps in CM-CONNECTED, where CM is abbreviated from Connection Management) and the radio access network (RAN) connection is released. The network can reach the inactive UE through RAN or CN Paging messages.

Broadcast/multicast service (MBS) is not yet specified in the first two new radio (NR) releases, i.e., 3GPP Rel-15 and Rel-16. Nevertheless, there are important use cases (e.g., public safety and mission critical, vehicle-to-everything (V2X) applications, transparent IPv4/IPv6 multicast delivery, IPTV, software delivery over wireless, group communications and IoT applications, but not limited to) for which broadcast/multicast could provide substantial improvements, especially regards to system efficiency and user experience.

To enable resource-efficient delivery of multicast/broadcast services, 3GPP has developed NR multicast and/or broadcast service (NR MBS) in 3GPP Rel-17, Single-Cell Point-to-Multipoint (SC-PTM) defined in LTE is the baseline. In 3GPP Rel-17, NG-RAN only specifies multicast for UEs in RRC_CONNECTED state, which may not fully fulfil the requirements of, e.g., Mission Critical Services, especially for cells with large number of UEs. Also, to always keep UEs in RRC_CONNECTED state is not power efficient. If the UE transits to RRC_INACTIVE for power saving and go back to RRC_CONNECTED for MBS reception, a serious service latency can be a problem. It is therefore important to support multicast for UEs in RRC_INACTIVE. Furthermore, when an RRC_INACTIVE UE is moving across cells (i.e., out of the transmission coverage of MBS session area), a non-negligible service latency due to the change of cell would be aggravated. Therefore, how to lower the latency for cell reselection to improve MBS service continuity is important in this field.

### SUMMARY

The disclosure can be used to improve the latency of MBS data transmission and achieve MBS service continuity during the change of serving cell.

In a first aspect of the present disclosure, provided is a cell reselection method for multicast and/or broadcast service (MBS) service continuity, performed by a power saving user equipment (UE) in a network, the method including: staying on a first cell for MBS data reception based on an MBS configuration in a power saving state: receiving a signaling from at least one of the first cell or at least one neighboring cell for the power saving UE to prioritize cells for cell reselection, wherein an MBS indication included in the signaling is configured to identify whether an MBS session of an associated cell is activated: and selecting a second cell from the at least one neighboring cell based on the MBS indication, and changing from the first cell to the second cell to camp on for the MBS data reception.

Optionally, the MBS session of the associated cell is deactivated if the MBS indication is set to one value, and the MBS session of the associated cell is activated for MBS in the power saving state if the MBS indication is set to another value different from the one value.

Optionally, a neighboring cell which has the activated MBS session is prioritized to be selected as the second cell.

Optionally, the second cell is selected by the UE further based on the detection of at least one of a new cell identifier or an MBS Temporary Mobile Group Identity (TMGI).

Optionally, the MBS indication is further configured to identify at least one of a point-to-multipoint (PTM) transmission manner or a point-to-point (PTP) transmission manner supported by the associated cell to transmit MBS data.

Optionally, the PTM transmission manner is supported if the MBS indication is set to a first value, the PTP transmission manner is supported if the MBS indication is set to a second value, and both the PTM transmission manner and the PTP transmission manner are supported if the MBS indication is set to a third value.

Optionally, a neighboring cell which supports a transmission manner that is the same as the transmission manner the UE has been used is prioritized to be selected as the second cell.

Optionally, the method further includes:
receiving an indication to indicate whether the transmission manner used by the first cell to transmit MBS data is the same with the at least one neighboring cell.

Optionally, a neighboring cell which has a PTM configuration as the same as the first cell is prioritized to be selected as the second cell.

Optionally, a neighboring cell which has the activated MBS session and has the PTM configuration as the same as the first cell is firstly selected as the second cell during cell reselection.

Optionally, the method further includes:
receiving an indication to indicate whether the PTM configuration used by the UE to receive MBS data from the first cell is the same with the at least one neighboring cell.

Optionally, the UE receives MBS data from the second cell without state transition.

Optionally, neighboring cell information which the UE can directly apply for cell reselection is included in the MBS configuration.

Optionally, all of suitable cells provided in stored neighboring cell information are cells that can provide MBS control and data channel to continue MBS data transmission via at least one of PTM or PTP transmission manner.

Optionally, the UE directly applies stored MBS configuration from the first cell for the MBS data reception when camping on the second cell.

Optionally, an MBS-acceptable cell is selected as the second cell on which the UE camps, and the MBS-acceptable cell is a cell providing MBS control and data channel to continue MBS data transmission via at least one of PTM or PTP transmission manner.

Optionally, the method further includes:
transmitting by the UE at least one of an MBS preamble or an MBS system information (SI) request to request joining an ongoing MBS session and to establish an associated MBS Packet Data Unit (PDU) session.

Optionally, the method further includes:
transmitting by the UE an MBS data request via a random access (RA) procedure or an MBS tracking area update to request joining an ongoing MBS session.

Optionally, if the MBS indication indicating the associated cell with a deactivated MBS session is detected, the method further includes:
transmitting by the UE at least one of an MBS preamble or an MBS system information (SI) request to activate the MBS session and to establish an associated MBS Packet Data Unit (PDU) session.

Optionally, if the MBS indication indicating the associated cell with a deactivated MBS session is detected, the method further includes:
transmitting by the UE an MBS data request via a random access (RA) procedure or an MBS tracking area update to request activating the MBS session.

Optionally, the UE camps on a non-MBS-acceptable cell if only the non-MBS-acceptable cell is detected, and the non-MBS-acceptable cell is a cell providing MBS data via unicast manner upon the UE in a non-power saving state.

Optionally, the method further includes:
receiving by the UE downlink control information (DCI) with scheduling information of the MBS data.

Optionally, at least one of associated identifiers or parameters of a radio access network (RAN) functional split node providing a cell are used during transmission of the MBS configuration, MBS data or paging.

In a second aspect of the present disclosure, provided is a method for providing multicast and/or broadcast service (MBS) service continuity, performed by a network node in a network, the method including: transmitting a signaling to a power saving user equipment (UE) for the UE to prioritize cells for cell reselection, wherein an MBS indication included in the signaling is configured to identify whether an MBS session of an associated cell is activated for the UE to decide whether to change from a serving cell to the associated cell to camp on for MBS data reception.

Optionally, the MBS session of the associated cell is deactivated if the MBS indication is set to one value, and the MBS session of the associated cell is activated for MBS for the UE in a power saving state if the MBS indication is set to another value different from the one value.

Optionally, if the MBS indication indicates that the associated cell has an activated MBS session, the associated cell is prioritized to be selected by the UE for cell reselection.

Optionally, the MBS indication is further configured to identify at least one of a point-to-multipoint (PTM) transmission manner or a point-to-point (PTP) transmission manner supported by the associated cell to transmit MBS data.

Optionally, the PTM transmission manner is supported if the MBS indication is set to a first value, the PTP transmission manner is supported if the MBS indication is set to a second value, and both the PTM transmission manner and the PTP transmission manner are supported if the MBS indication is set to a third value.

Optionally, if the MBS indication indicates that the associated cell supports a transmission manner that is the same as the transmission manner the UE has been used, the associated cell is prioritized to be selected by the UE for cell reselection.

Optionally, the method further includes:
transmitting an indication to indicate whether the transmission manner used by the serving cell to transmit MBS data is the same with the associated cell.

Optionally, if the associated cell has a PTM configuration as the same as the serving cell, the associated cell is prioritized to be selected by the UE for cell reselection.

Optionally, if the associated cell has the activated MBS session and the PTM configuration as the same as the serving cell, the associated cell is firstly selected by the UE for cell reselection.

Optionally, the method further includes:
transmitting an indication to indicate whether the PTM configuration used by the UE to receive MBS data from the serving cell is the same with the associated cell.

Optionally, the network node shares a same PTM configuration with other network nodes in the network.

Optionally, the method further includes:
receiving MBS data from a core network by shared MBS delivery or by individual MBS delivery.

Optionally, the method further includes:
transmitting to the UE neighboring cell information which the UE can directly apply for cell reselection.

Optionally, the neighboring cell information includes suitable cells, and all of the suitable cells are cells that can provide MBS control and data channel to continue MBS data transmission via at least one of PTM or PTP transmission manner.

Optionally, the transmitted signaling indicates a presence of the MBS indication, which indicates the associated cell is an MBS-acceptable cell, which is a cell providing MBS control and data channel to continue MBS data transmission via at least one of PTM or PTP transmission manner.

Optionally, the method further includes:
receiving by the network node from the UE at least one of an MBS preamble or an MBS system information (SI) request to request joining an ongoing MBS session and to establish an associated MBS Packet Data Unit (PDU) session.

Optionally, the method further includes:
receiving by the network node from an MBS data request via a random access (RA) procedure or an MBS tracking area update to request joining an ongoing MBS session.

Optionally, if the MBS indication indicates the associated cell with a deactivated MBS session, the method further includes:
receiving by the network node from the UE at least one of an MBS preamble or an MBS system information (SI) request to activate the MBS session and to establish an associated MBS Packet Data Unit (PDU) session.

Optionally, if the MBS indication indicates the associated cell with a deactivated MBS session, the method further includes:
receiving by the network node from the UE an MBS data request via a random access (RA) procedure or an MBS tracking area update to request activating the MBS session.

Optionally, the transmitted signaling indicates an absence of the MBS indication, which indicates the associated cell is a non-MBS-acceptable cell, which is a cell providing MBS data via unicast manner upon the UE in a non-power saving state.

Optionally, the method further includes:
transmitting to the UE by the network node downlink control information (DCI) with scheduling information of the MBS data.

Optionally, at least one of associated identifiers or parameters of a radio access network (RAN) functional split node are used during transmission of the MBS configuration, MBS data or paging.

In a third aspect of the present disclosure, a user equipment includes a memory and a processor coupled to the memory, the processor configured to call and run program instructions stored in a memory, to execute the above method.

In a fourth aspect of the present disclosure, a network node includes a memory and a processor coupled to the memory, the processor configured to call and run program instructions stored in a memory, to execute the above method.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1A is a schematic diagram illustrating a communication controlling system according to an embodiment of the present disclosure.

FIG. 1B is a block diagram of a user equipment and a base station of wireless communication in a communication controlling system according to an embodiment of the present disclosure.

FIG. 2A is a schematic diagram illustrating user plane radio protocol architecture within gNB and UE for NR MBS.

FIG. 2B is a schematic diagram illustrating a gNB further including a centralized unit (CU) and a plurality of distributed unit (DUs).

FIG. 3 shows an overview of UE RRC state transitions in NR.

FIG. 4A is a flowchart of a cell reselection method for MBS service continuity, performed by a user equipment, according to some embodiments of the present disclosure.

FIG. 4B is a flowchart of a method for providing MBS service continuity, performed by a network node, according to some embodiments of the present disclosure.

FIG. 5 is a flowchart illustrating an MBS-enabled UE(s) manually reselects a new suitable cell between NG-RAN nodes with activated shared MBS delivery method according to a first embodiment of the present disclosure.

FIG. 6 is a flowchart illustrating an MBS-enabled UE(s) manually reselects a new MBS-acceptable cell between NG-RAN nodes with activated shared MBS delivery method according to a second embodiment of the present disclosure.

FIG. 7 is a flowchart illustrating an MBS-enabled UE(s) manually reselects a new MBS-acceptable cell between NG-RAN nodes with activated shared MBS delivery method in RRC_INACTIVE state according to a third embodiment of the present disclosure.

FIG. 8 is a flowchart illustrating an MBS-enabled UE(s) manually reselects a new MBS-acceptable cell between NG-RAN nodes with individual MBS delivery and activated shared MBS delivery methods according to a fourth embodiment of the present disclosure.

FIG. 9 is a flowchart illustrating an MBS-enabled UE(s) manually reselects a new non-MBS-acceptable cell between NG-RAN nodes with individual MBS delivery and activated shared MBS delivery methods according to a fifth embodiment of the present disclosure.

FIG. 10 is a flowchart illustrating an MBS-enabled UE(s) manually reselects a new suitable cell between NG-RAN nodes with deactivated shared MBS delivery method according to a sixth embodiment of the present disclosure.

FIG. 11 is a flowchart illustrating an MBS-enabled UE(s) manually reselects a new MBS-acceptable cell between NG-RAN nodes with deactivated shared MBS delivery method according to a seventh embodiment of the present disclosure.

FIG. 12 is a flowchart illustrating an MBS-enabled UE(s) manually reselects a new MBS-acceptable cell between NG-RAN nodes with deactivated shared MBS delivery method in RRC_INACTIVE state according to an eighth embodiment of the present disclosure.

FIG. 13 is a flowchart illustrating an MBS-enabled UE(s) manually reselects a new MBS-acceptable cell between NG-RAN nodes with individual MBS delivery and deactivated shared MBS delivery methods according to a ninth embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In this document, the symbol “/” should be interpreted to indicate “and/or.” A combination such as “at least one of A, B, or C,” “one or more of A, B, or C,” “at least one of A, B, and C,” “one or more of A, B, and C,” or “A, B, and/or C” may be A only, B only, C only, A and B, A and C, B and C, or A and B and C, where any combination may contain one or more members of A, B, or C.

It should be noted that uncles otherwise specified clearly, “manual” or “manually” used in this disclosure to describe that a UE manually reselects a cell is not intended to mean a user of the UE manually performs the cell reselection, but instead, is to emphasize that whether to perform the cell reselection is mainly decided by the UE.

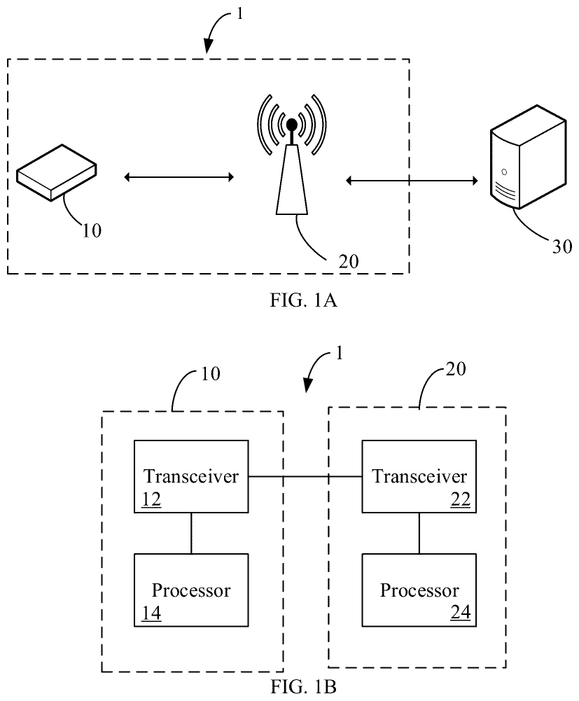

A schematic view and a functional block diagram of a communication controlling system 1 according to the present disclosure are shown in FIG. 1A and FIG. 1B respectively. The communication controlling system 1 includes a user equipment 10 and a base station (which is a network node such as a NG-RAN node) 20. The user equipment 10 and the base station 20 may communicate with each other either wirelessly or in a wired way. The base station 20 and a next generation core network 30 may also communicate with each other either wirelessly or in a wired way. When the communication controlling system 1 complies with the New Radio (NR) standard of the 3rd Generation Partnership Project (3GPP), the next generation core network (5GCN) 30 is a backend serving network system and may include an Access and Mobility Management Function (AMF), User Plane Function (UPF), and a Session Management Function (SMF).

The user equipment 10 may be an MBS-enabled or an MBS-capable apparatus, but the present disclosure is not limited to this. The user equipment 10 includes a transceiver 12 and a processor 14, which are electrically connected with each other. The base station 20 includes a transceiver 22 and a processor 24, which are electrically connected with each other. The transceiver 12 of the user equipment 10 is configured to transmit a signal to the base station 20 (and receive a signal from the base station 20) and the processor 24 of the base station 20 processes the signal, the transceiver 22 of the base station 20 is configured to transmit a signal to the user equipment 10 (and receive a signal from the user equipment 10) and the processor 14 of the user equipment 10 processes the signal. In this way, the user equipment 10 communicates with the base station 20 each other.

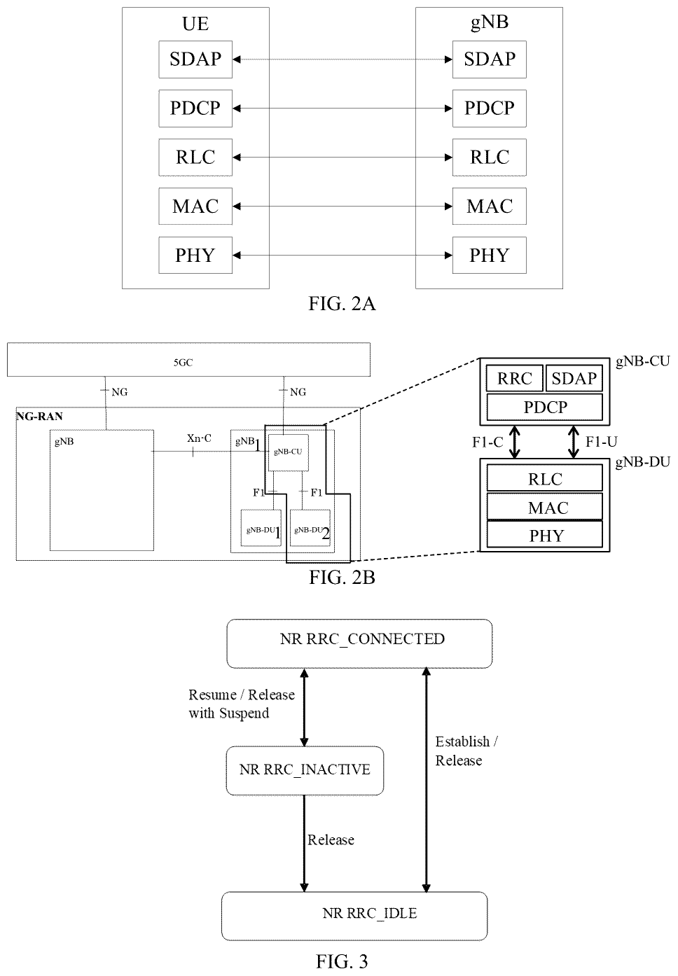

In 5G, point to multipoint transmission in a cell (i.e., single cell-point to multipoint, SC-PTM) is supported for new radio multicast and broadcast service (NR MBS). The user plane radio protocol architecture within the base station (gNB) and UE for NR MBS is shown in FIG. 2A, which includes Service Data Adaptation Protocol (SDAP), Packet Data Convergence Protocol (PDCP), Radio Link Control (RLC), Medium Access Control (MAC). In NR, if an MBS session can be mapped to multiple 5G MBS QoS flows, the NR MBS QoS flows are mapped to NR MBS radio bearers by NR SDAP. In RAN functional split, the gNB further includes a centralized unit (CU) and a plurality of distributed unit (DUs) as shown in FIG. 2B. The protocol stack of CU includes an RRC layer, a SDAP layer, and a PDCP layer, while the protocol stack of DU includes an RLC layer, a MAC layer, and a PHY layer. The F1 interface between the CU and DU is established between the PDCP layer of the protocol stack and the RLC layer of the protocol stack.

FIG. 3 shows an overview of UE RRC state transitions in NR. A UE is either in RRC_CONNECTED state or in RRC_INACTIVE state when an RRC connection has been established. In RRC_CONNECTED state, the UE joins an MBS session identified by the associated MBS Session ID (e.g., Temporary Mobile Group Identity, TMGI). The NR MBS configuration is periodically transmitted via MBS Control Channel (MCCH) from which UE(s) applies the received NR MBS configuration for MBS data reception via MBS Traffic Channel (MTCH). In some cases, the neighboring cell information (e.g., MBS indication, PTM configuration) which the UE can directly apply for cell reselection is included in NR MBS configuration for MBS service continuity. In case MBS reception (i.e., multicast and/or broadcast reception) is supported by UE in RRC_INACTIVE state, the network and UE store the UE context for multicast and/or broadcast service with lower power consumption. The stored UE context may include the MBS session the UE is interested in, and/or the NR MBS configuration that has been used previously. The network could identify which UE is interested in the MBS session from the MBS context in the UE context. In addition, the network provides additional information for UE in RRC_INACTIVE state. If the configuration used in RRC_INACTIVE state is a separate configuration, the UE can receive a dedicated signaling (e.g., RRCRelease) with NR MBS configuration (e.g., MBS session ID, G-RNTI, G-CS-RNTI, PTM/PTP configuration of MRB, supporting frequency, the scheduling information of MTCH, DRX for MBS, HARQ configuration, MBS indication, etc.) and resumes the RRC connection if necessary. After the successful reception of the NR MBS configuration, the UE can transit to RRC_INACTIVE state for the reception of MBS data. If the RRC connection is released, the UE transits to RRC_IDLE state.

From core network (5GCN) point of view, there are two methods defined for the delivery of an MBS session:
Shared MBS delivery method: 5GCN receives a single copy of MBS data packets and delivers a single copy of those MBS packets to a NG-RAN node, which then delivers them to one or multiple UEs. It means only the NG-RAN nodes supporting MBS capability can receive MBS data by the shared MBS delivery method. This method is used to save 5GCN resource for MBS data transmission.
Individual MBS delivery method: 5GCN receives a single copy of MBS data packets and delivers separate copies of those MBS data packets to individual UEs via per-UE PDU sessions. It is used for the cases wherein the NG-RAN node does not support MBS capability, but MBS data is still required due to manually cell reselection (e.g., the change of serving cell, mobility scenario).

From radio access network (i.e., NG-RAN, e.g., gNB, cell) point of view, upon the reception of MBS data from 5GCN, the NG-RAN node will deliver the MBS data towards the UE(s). The NG-RAN node would use one or more multicast radio bearer(s) (MRB) for MBS data transmission. Each MRB is split into a point-to-multipoint (PTM) and a point-to-point (PTP) leg. It means the MBS data could be transmitted by either PTM or PTP transmission manner. The transmission manner would be decided by the NG-RAN node based on the network condition (e.g., QoS requirement, number of serving/interesting UEs, unicast/MBS traffic loading, UE locations, channel state information, etc.). The PTM configuration is transmitted to the UE(s) in RRC_CONNECTED/RRC_INACTIVE/RRC_IDLE through dedicated signaling (e.g., RRCReconfiguration, RRCRelease, Paging). During cell reselection, there may be cases that the neighbor NG-RAN nodes share the same PTM configuration via backhaul interface or Uu interface for MBS service continuity. For reducing signaling overhead, there may be at least one bit in the dedicated signaling (e.g., RRCReconfiguration, RRCRelease, Paging) to indicate whether the PTM configuration is the same with the neighbor NG-RAN node(s).

Considering on UE power efficiency and mobility, the serving NG-RAN node provides the NR MBS/PTM configurations (e.g., via system information, MCCH, dedicated RRC signaling) optionally including the neighboring cell (i.e., suitable cell) information which the UE can directly apply for cell reselection. The continuous MBS would be provided by the suitable cell without UE state transition. When the UE moves from the serving NG-RAN node to a new NG-RAN node, the NR MBS configuration might be updated in the new NG-RAN node which is MBS supporting cell. The NG-RAN node can be categorized according to whether MBS delivery method it offers:
MBS-acceptable cell: the MBS-acceptable cell is a cell on which the UE may camp to obtain MBS data via shared MBS delivery method. Such a cell shall provide MBS control and data channel to continue the MBS transmission via PTM and/or PTP transmission manner. There is an MBS indication (e.g., transmitted in system information, MCCH, paging, NAS signaling) to identify such the activated/deactivated MBS cell for UE manually cell reselection. In some cases, the MBS indication can be used to identify the PTM and/or PTP transmission manner. In some cases, the UE would like to select the same PTM configuration upon the change of cell(s). The suitable cell provided in stored NR MBS configuration is generally an MBS-acceptable cell.
Non-MBS-acceptable cell: the non-MBS-acceptable cell is a cell on which the UE may camp to obtain MBS data via individual MBS delivery method. Such a cell may provide MBS data via unicast manner upon UE in the RRC_CONNECTED state.

An MBS-enabled UE should monitor a group notification (e.g., system information, paging notification), MCCH/MTCH channel for MBS data reception when joining at least one of MBS sessions. The MBS-enabled UE needs to receive MBS data continually when changing its serving cell(s). In this circumstance, the UE would manually (re) select a new cell based on the detection of new cell identifier, MBS session identifier (e.g., TMGI), and/or MBS indication. The detection of new cell identifier can be used to identify whether a suitable cell it is. The detected new MBS session identifier can be used to identify whether an MBS-acceptable cell it is, and which the MBS session it offers. The MBS indication can be used for UE to prioritize which cell it should instantly camp on. For example, but not limited to, an MBS indication is one bit transmitted in group notification (e.g., system information, paging) to identify whether the cell is an MBS-acceptable cell and whether the MBS session is activated. If the MBS indication is set to 0, it means the MBS session of MBS-acceptable cell is deactivated. The UE should transmit a request for MBS session activation. While the MBS indication is set to 1, it means the MBS session of MBS-acceptable cell is activated for MBS in RRC_INACTIVE. If the MBS indication is absent, it means the non-MBS-acceptable cell it is. Based on the received MBS indication, the UE may choose the activated suitable/MBS-acceptable cell with the same PTM configuration firstly during cell reselection. In further cases, an MBS indication is more than one bit (e.g., 2 bits) transmitted in group notification (e.g., system information, paging) to identify whether the MBS session is supported by PTM and/or PTP transmission manner. If the MBS indication is set to 00, it means the MBS session of MBS-acceptable cell is deactivated. While the MBS indication is set to 01 and 10, it means the one of PTM and PTP is supported respectively. If the MBS indication is set to 11, it means both PTM and PTP transmission manner are supported in the MBS-acceptable cell. The UE can prioritize to camp on the cell which support of transmission manner is the same as it has been used. It would be facilitated for the UE to receive MBS data continuously if the UE selects the same PTM configuration between serving and new cells. According to the monitoring group notification (e.g. system information, paging)/MBS information from serving and neighboring cell, if a suitable cell is detected, the UE can directly apply the stored neighboring cell information (e.g., NR MBS configuration) for monitoring the MBS information (e.g., MBS data, MBS paging notification). The MBS data can be received without UE state transition. If an MBS-acceptable cell, but not in the suitable cell list, is detected, the UE can either transit to RRC_CONNECTED state or keep in RRC_INACTIVE state for MBS service continuity. In some cases, if only a non-MBS-acceptable cell is detected, the UE should go to RRC CONNECTED state and establish per-UE PDU session for receiving the MBS data. The non-MBS-acceptable cell may provide the associated MBS data via unicast manner to the UE(s).

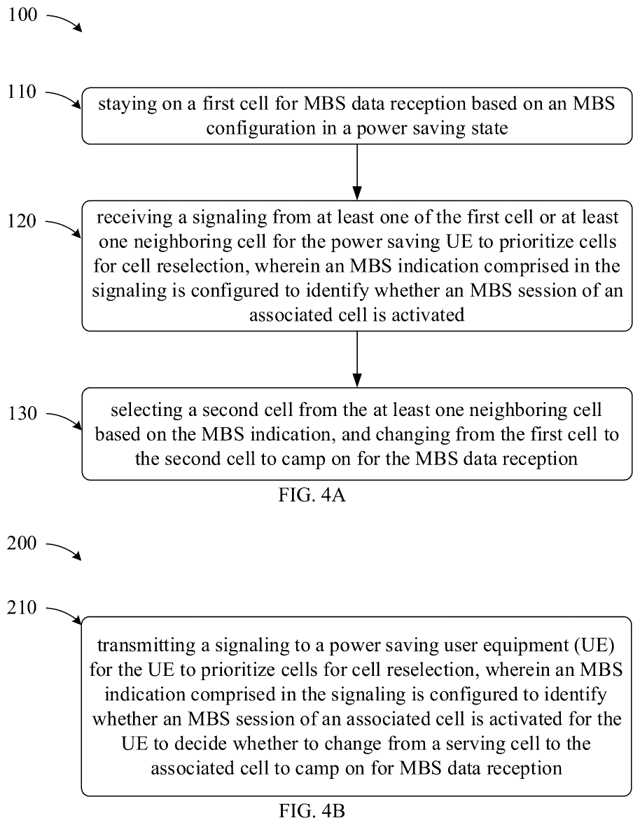

Based on above inventive concepts, the present disclosure provides a cell reselection method. FIG. 4A is a flowchart of a cell reselection method 100 for MBS service continuity, performed by a user equipment, according to some embodiments of the present disclosure. The method 100 may include the following steps.

In step 110, the UE stays on a first cell for MBS data reception based on an MBS configuration in a power saving state (e.g., RRC_INACTIVE state and RRC_IDLE state). The first cell may be a serving cell serving the UE. The serving cell may configure the UE with the MBS configuration such that the UE may receive MBS data based on the MBS configuration. The UE may reselect a new cell for MBS data reception while in the power saving state. Meanwhile, the UE changes from the first cell to the new cell to camp on for the MBS data reception.

In step 120, the UE receives a signaling from at least one of the first cell or at least one neighboring cell for the power saving UE to prioritize cells for cell reselection. The signaling includes an MBS indication, which is configured to identify whether an MBS session of an associated cell is activated. The MBS indication may be received from the first cell (serving cell) or from a neighboring cell, or both the first cell and the neighboring cell may send the MBS indication to the UE. Based on the MBS indication, the power saving UE can prioritize cells for cell reselection. The MBS indication can be used to identify whether an MBS session of an associated cell is activated. If the MBS indication is received from the first cell, the associated cell may be any neighboring cell suitable for the power saving UE for cell reselection. If the MBS indication is received from the neighboring cell, the associated cell may be referred to neighboring cell itself, and the MBS indication indicates whether the neighboring cell has an activated MBS session.

In an embodiment, the MBS session of the associated cell is deactivated if the MBS indication is set to one value (e.g., 0), and the MBS session of the associated cell is activated for MBS in the power saving state if the MBS indication is set to another value (e.g., 1) different from the one value. A neighboring cell which has the activated MBS session is prioritized to be selected as the second cell.

In an embodiment, the MBS indication is further configured to identify at least one of a point-to-multipoint (PTM) transmission manner or a point-to-point (PTP) transmission manner supported by the associated cell to transmit MBS data. In an exemplary example, the PTM transmission manner is supported if the MBS indication is set to a first value (e.g., 01), the PTP transmission manner is supported if the MBS indication is set to a second value (e.g., 10), and both the PTM transmission manner and the PTP transmission manner are supported if the MBS indication is set to a third value (e.g., 11). A neighboring cell which supports a transmission manner that is the same as the transmission manner the UE has been used is prioritized to be selected as the second cell. The method may further include receiving an indication to indicate whether the transmission manner used by the first cell to transmit MBS data is the same with the at least one neighboring cell.

In an embodiment, a neighboring cell which has a PTM configuration as the same as the first cell is prioritized to be selected as the second cell. The method may further include receiving an indication to indicate whether the PTM configuration used by the UE to receive MBS data from the first cell is the same with the at least one neighboring cell. In another embodiment, a neighboring cell which has the activated MBS session and has the PTM configuration as the same as the first cell is firstly selected as the second cell during cell reselection.

In step 130, the UE selects a second cell from the at least one neighboring cell based on the MBS indication, and changing from the first cell to the second cell to camp on for the MBS data reception. From the first cell to the second cell, MBS service continuity still maintains. The UE may receive MBS data from the second cell with or without state transition. That is, the UE may transit from a power saving state (e.g., RRC_INACTIVE state) to a non-power saving state (e.g., RRC_CONNECTED) to receive the MBS data from the second cell, or may stay in the power saving state to receive the MBS data from the second cell.

In an embodiment, neighboring cell information which the UE can directly apply for cell reselection is included in the MBS configuration. All of suitable cells provided in stored neighboring cell information are cells that can provide MBS control and data channel to continue MBS data transmission via at least one of PTM or PTP transmission manner. In another embodiment, the UE can directly apply stored MBS configuration from the first cell for the MBS data reception when camping on the second cell.

In an embodiment, an MBS-acceptable cell is selected as the second cell on which the UE camps, and the MBS-acceptable cell is a cell providing MBS control and data channel to continue MBS data transmission via at least one of PTM or PTP transmission manner. The method may further include transmitting by the UE at least one of an MBS preamble or an MBS system information (SI) request to request joining an ongoing MBS session and to establish an associated MBS Packet Data Unit (PDU) session. Alternatively, The method may further include transmitting by the UE an MBS data request via a random access (RA) procedure or an MBS tracking area update to request joining an ongoing MBS session.

In an embodiment, if the MBS indication indicating the associated cell with a deactivated MBS session is detected, the method may further include transmitting by the UE at least one of an MBS preamble or an MBS system information (SI) request to activate the MBS session and to establish an associated MBS Packet Data Unit (PDU) session. In another embodiment, if the MBS indication indicating the associated cell with a deactivated MBS session is detected, the method may further include transmitting by the UE an MBS data request via a random access (RA) procedure or an MBS tracking area update to request activating the MBS session.

In an embodiment, the UE camps on a non-MBS-acceptable cell if only the non-MBS-acceptable cell is detected, and the non-MBS-acceptable cell is a cell providing MBS data via unicast manner upon the UE in a non-power saving state. The method may further include receiving by the UE downlink control information (DCI) with scheduling information of the MBS data.

With the proposed method 100 illustrated above, based on the MBS indication, the power saving UE can quickly perform cell reselection without having to perform an additional procedure to inquire whether the neighboring cell is a suitable cell. Therefore, the invention can improve the latency of MBS data transmission and achieve MBS service continuity during the change of serving cell.

Based on above inventive concepts, the present disclosure provides a method for providing MBS service continuity. FIG. 4B is a flowchart of a method 200 for providing MBS service continuity, performed by a network node, according to some embodiments of the present disclosure. The method 200 may include the following steps.

In step 210, the network node (e.g., a base station, a NG-RAN node) transmits a signaling to a power saving user equipment (UE) for the UE to prioritize cells for cell reselection. The signaling includes an MBS indication, which is configured to identify whether an MBS session of an associated cell is activated for the UE to decide whether to change from a serving cell to the associated cell to camp on for MBS data reception. The network node may provide a serving cell serving the UE, or may correspond to a neighboring cell neighboring the UE. Based on the MBS indication, the power saving UE can prioritize cells for cell reselection. The MBS indication can be used to identify whether an MBS session of an associated cell is activated. The associated cell may be any neighboring cell suitable for the power saving UE for cell reselection, or may be referred to a neighboring cell transmitting the signaling including the MBS indication. The MBS indication indicates whether the neighboring cell has an activated MBS session. This MBS indication aids the UE to decide whether to change from a serving cell to the associated cell to camp on for MBS data reception. This method 200 can be referred to above-described method 100 for further details.

With the proposed method 200 illustrated above, based on the MBS indication, the power saving UE can quickly perform cell reselection without having to perform an additional procedure to inquire whether the neighboring cell is a suitable cell. Therefore, the invention can improve the latency of MBS data transmission and achieve MBS service continuity during the change of serving cell.

Further details of the invention are described as follows.

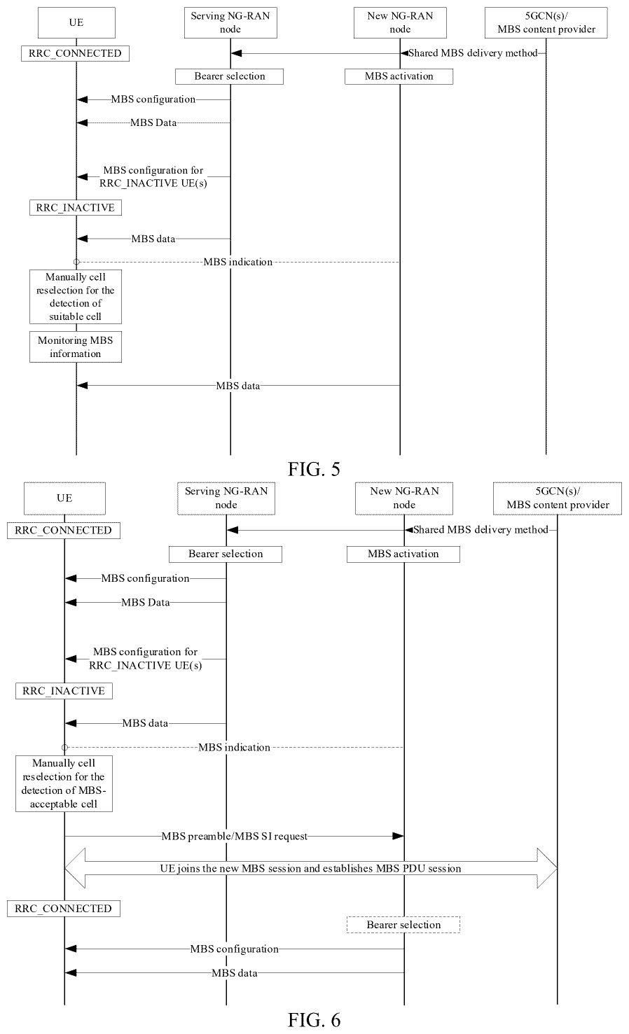

FIG. 5 shows an MBS-enabled UE(s) manually reselects a new suitable cell between NG-RAN nodes with activated shared MBS delivery method according to a first embodiment of the present disclosure. A UE connects to a serving NG-RAN node to join at least one of MBS sessions. The serving NG-RAN node which is an MBS-acceptable cell would decide the MBS bearer transmission manner (i.e., PTM and/or PTP) based on the network condition (e.g., QoS requirement, number of serving/interesting UEs, unicast/MBS traffic loading, UE locations, channel state information, etc.). If the UE gets the NR MBS configuration of serving NG-RAN node, it could receive the MBS data in RRC_CONNECTED accordingly. For UE power efficiency, it is beneficial to enable the MBS reception in RRC_INACTIVE. The NR MBS configuration used in RRC_INACTIVE state would be the same as used in RRC_CONNECTED state or be a different configuration from RRC_CONNECTED state. If the configuration used in RRC_INACTIVE state is a separate configuration, the UE can receive a dedicated signaling (e.g., RRCRelease) with NR MBS configuration (e.g., including MBS session ID, G-RNTI, G-CS-RNTI, PTM/PTP configuration of MRB, the scheduling information of MTCH, DRX for MBS, HARQ configuration, MBS indication, etc.) for MBS data reception. The provided NR MBS configuration is optionally including the neighboring cell (e.g., suitable cell) information which the UE can directly apply for cell reselection. When transiting to RRC_INACTIVE state, the 5GCN/network could identify which UE is interested in the MBS session from the MBS context in the stored UE context. The UE will keep monitoring an MBS indication, group notification and/or MBS related information (e.g., in system information, paging) for MBS reception. During cell reselection, the UE would like to select the same transmission manner/bearer configuration based on the stored NR MBS configuration since there may be the cases that the neighboring NG-RAN nodes share the same PTM configuration with the serving NG-RAN node via backhaul interface or Uu interface for MBS service continuity. Upon the reception of group notification (e.g., system information, paging) from the serving and neighboring cell(s), the UE would manually (re)select a new NG-RAN node based on the detection of new cell identifier, MBS session identifier (e.g., TMGI), and/or MBS indication. If an activated MBS indication of suitable cell is detected and is matching to the UE's demand (e.g., the stored PTM configuration), the UE can manually reselect the suitable cell and directly apply the associated stored configuration for monitoring the MBS information (e.g., NR MBS configuration, MBS paging notification) on the suitable cell. Then the MBS data can be received without UE state transition. A group notification with the updated NR MBS configuration (e.g., via paging) would be transmitted on the MBS paging occasion/RAN paging cycle (not shown), if necessary. In general, the manual cell reselection is based on UE's configuration and the associated MBS QoS requirement. The UE may prioritize to choose an activated suitable cell with the same transmission manner/PTM configuration. A seamless MBS would be provided by the suitable cell without UE state transition.

FIG. 6 shows an MBS-enabled UE(s) manually reselects a new MBS-acceptable cell between NG-RAN nodes with activated shared MBS delivery method according to a second embodiment of the present disclosure. A UE connects to a serving NG-RAN node to join at least one of MBS sessions. The serving NG-RAN node which is an MBS-acceptable cell would decide the MBS bearer transmission manner (i.e., PTM and/or PTP) based on the network condition (e.g., QoS requirement, number of serving/interesting UEs, unicast/MBS traffic loading, UE locations, channel state information, etc.). If the UE gets the NR MBS configuration of serving NG-RAN node, it could receive the MBS data in RRC_CONNECTED accordingly. For UE power efficiency, it is beneficial to enable the MBS reception in RRC_INACTIVE. The NR MBS configuration used in RRC_INACTIVE state would be the same as used in RRC_CONNECTED state or be a different configuration from RRC_CONNECTED state. If the configuration used in RRC_INACTIVE state is a separate configuration, the UE can receive a dedicated signaling (e.g., RRCRelease) with NR MBS configuration (e.g., including MBS session ID, G-RNTI, G-CS-RNTI, PTM/PTP configuration of MRB, the scheduling information of MTCH, DRX for MBS, HARQ configuration, etc.) for MBS data reception. The provided NR MBS configuration is optionally including the neighboring cell (e.g., suitable cell) information which the UE can directly apply for cell reselection. When transiting to RRC_INACTIVE state, the UE will keep monitoring an MBS indication, group notification and/or MBS related information (e.g., in system information, paging) for MBS reception. During cell reselection, the UE would like to select the same transmission manner/bearer configuration based on the stored NR MBS configuration since there may be the cases that the neighboring NG-RAN nodes share the same PTM configuration with the serving NG-RAN node via backhaul interface or Uu interface for MBS service continuity. Upon the reception of group notification (e.g., system information, paging) from the serving and neighboring cell(s), the UE would manually (re) select a new NG-RAN node based on the detection of new cell identifier, MBS session identifier (e.g., TMGI), and/or MBS indication. If an activated MBS indication of MBS-acceptable cell is detected and the service (e.g., channel quality) is better than the serving NG-RAN node, the UE can manually reselect the MBS-acceptable cell and try to camp on it. A preconfigured MBS preamble/MBS system information (SI) request is transmitted by the UE to perform dedicated RACH/on-demand SI and to establish the associated MBS PDU session for joining an ongoing MBS session. The 5GCN/network could identify the UE is interested in which MBS session from the MBS context in the stored UE context. In this way, the UE will transit to the RRC_CONNECTED state for connecting with the new NG-RAN node. If the joining MBS session is accepted, the bearer selection might be redetermined and a new MBS configuration and the MBS data could be received accordingly. In general, the manual cell reselection is based on UE's configuration and the associated MBS QoS requirement. The UE may firstly choose an activated MBS-acceptable cell with the same transmission manner/PTM configuration. A continuous MBS would be provided by the MBS-acceptable cell, which is triggered by the MBS-enabled UE in RRC_CONNECTED.

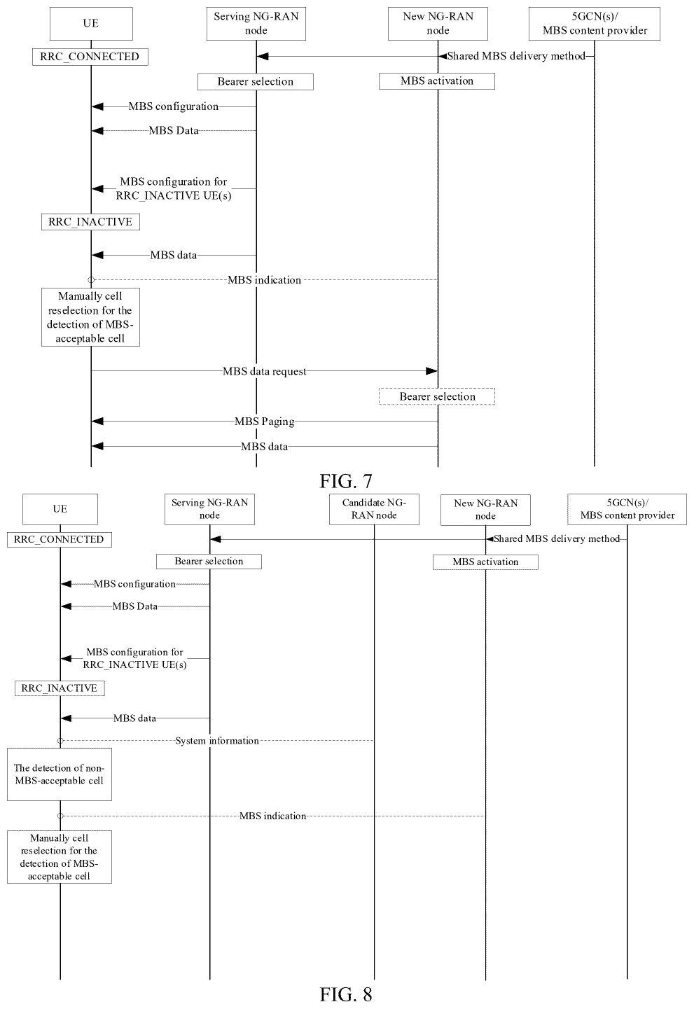

FIG. 7 shows an MBS-enabled UE(s) manually reselects a new MBS-acceptable cell between NG-RAN nodes with activated shared MBS delivery method in RRC_INACTIVE state according to a third embodiment of the present disclosure. A UE connects to a serving NG-RAN node to join at least one of MBS sessions. The serving NG-RAN node which is an MBS-acceptable cell would decide the MBS bearer transmission manner (i.e., PTM and/or PTP) based on the network condition (e.g., QoS requirement, number of serving/interesting UEs, unicast/MBS traffic loading, UE locations, channel state information, etc.). If the UE gets the NR MBS configuration of serving NG-RAN node, it could receive the MBS data in RRC_CONNECTED accordingly. For UE power efficiency, it is beneficial to enable the MBS reception in RRC_INACTIVE. The NR MBS configuration used in RRC_INACTIVE state would be the same as used in RRC_CONNECTED state or be a different configuration from RRC_CONNECTED state. If the configuration used in RRC_INACTIVE state is a separate configuration, the UE can receive a dedicated signaling (e.g., RRCRelease) with NR MBS configuration (e.g., including MBS session ID, G-RNTI, G-CS-RNTI, PTM/PTP configuration of MRB, the scheduling information of MTCH, DRX for MBS, HARQ configuration, etc.) for MBS data reception. The provided NR MBS configuration is optionally including the neighboring cell (e.g., suitable cell) information which the UE can directly apply for cell reselection. When transiting to RRC_INACTIVE state, the UE will keep monitoring an MBS indication, group notification and/or MBS related information (e.g., in system information, paging) for MBS reception. During cell reselection, the UE would like to select the same transmission manner/bearer configuration based on the stored NR MBS configuration since there may be the cases that the neighboring NG-RAN nodes share the same PTM configuration with the serving NG-RAN node via backhaul interface or Uu interface for MBS service continuity. Upon the reception of group notification (e.g., system information, paging) from the serving and neighboring cell(s), the UE would manually (re) select a new NG-RAN node based on the detection of new cell identifier, MBS session identifier (e.g., TMGI), and/or MBS indication. If an activated MBS indication of MBS-acceptable cell is detected and the service (e.g., channel quality) is better than the serving NG-RAN node, the UE can manually reselect the MBS-acceptable cell and try to camp on it. An MBS data request (e.g., via 2/4-step RACH SDT, MBS tracking area update) is transmitted by the UE to request joining an ongoing MBS session. The 5GCN/network could identify the UE is interested in which MBS session from the MBS context in the stored UE context. In this way, the new NG-RAN node would redetermine the MBS bearer transmission manner (i.e., PTM and/or PTP) based on the UE request, if necessary. Then a group notification with the updated NR MBS configuration (e.g., via paging) would be transmitted on the MBS paging occasion/RAN paging cycle. The UE could receive the MBS data in RRC_INACTIVE accordingly. In general, the manual cell reselection is based on channel condition and the associated MBS QoS requirement. The UE may firstly choose an activated MBS-acceptable cell with the same transmission manner/PTM configuration. A continuous MBS would be provided by the MBS-acceptable cell, which is triggered by the MBS-enabled UE in RRC_INACTIVE.

FIG. 8 shows an MBS-enabled UE(s) manually reselects a new MBS-acceptable cell between NG-RAN nodes with individual MBS delivery and activated shared MBS delivery methods according to a fourth embodiment of the present disclosure. A UE connects to a serving NG-RAN node to join at least one of MBS sessions. The serving NG-RAN node which is an MBS-acceptable cell would decide the MBS bearer transmission manner (i.e., PTM and/or PTP) based on the network condition (e.g., QOS requirement, number of serving/interesting UEs, unicast/MBS traffic loading, UE locations, channel state information, etc.). If the UE gets the NR MBS configuration of serving NG-RAN node, it could receive the MBS data in RRC_CONNECTED accordingly. For UE power efficiency, it is beneficial to enable the MBS reception in RRC_INACTIVE. The NR MBS configuration used in RRC_INACTIVE state would be the same as used in RRC_CONNECTED state or be a different configuration from RRC_CONNECTED state. If the configuration used in RRC_INACTIVE state is a separate configuration, the UE can receive a dedicated signaling (e.g., RRCRelease) with NR MBS configuration (e.g., including MBS session ID, G-RNTI, G-CS-RNTI, PTM/PTP configuration of MRB, the scheduling information of MTCH, DRX for MBS, HARQ configuration, etc.) for MBS data reception. The provided NR MBS configuration is optionally including the neighboring cell (e.g., suitable cell) information which the UE can directly apply for cell reselection. When transiting to RRC_INACTIVE state, the 5GCN/network could identify which UE is interested in the MBS session from the MBS context in the stored UE context. The UE will keep monitoring an MBS indication, group notification and/or MBS related information (e.g., in system information, paging) for MBS reception. During cell reselection, the UE would like to select the same transmission manner/bearer configuration based on the stored NR MBS configuration since there may be the cases that the neighboring NG-RAN nodes share the same PTM configuration with the serving NG-RAN node via backhaul interface or Uu interface for MBS service continuity. Upon the reception of group notification (e.g., system information, paging) from the serving and neighboring cell(s), the UE would manually (re) select a new NG-RAN node based on the detection of new cell identifier, MBS session identifier (e.g., TMGI), and/or MBS indication. If a non-MBS-acceptable cell with an absent MBS indication is detected, the UE would like to skip to camp on the candidate NG-RAN node and keep searching for a new NG-RAN node which is an MBS-acceptable cell. Upon the detection of an activated MBS-acceptable cell, the UE can manually reselect for camping on it. The operations of an activated MBS-acceptable cell reselection have been described in detail in the aforesaid first to third embodiments, and thus will not be repeated herein. In general, the UE may prefer to choose an activated suitable/MBS-acceptable cell other than a non-MBS-acceptable cell. A continuous MBS would be provided by a suitable/MBS-acceptable cell, which is triggered by the MBS-enabled UE.

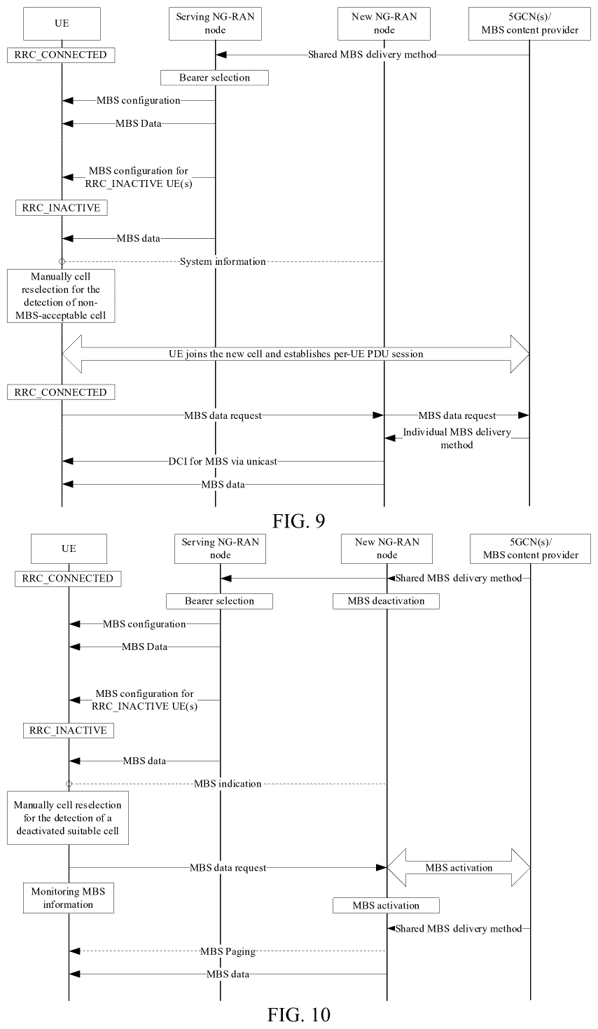

FIG. 9 shows an MBS-enabled UE(s) manually reselects a new non-MBS-acceptable cell between NG-RAN nodes with individual MBS delivery and activated shared MBS delivery methods according to a fifth embodiment of the present disclosure. A UE connects to a serving NG-RAN node to join at least one of MBS sessions. The serving NG-RAN node which is an MBS-acceptable cell would decide the MBS bearer transmission manner (i.e., PTM and/or PTP) based on the network condition (e.g., QOS requirement, number of serving/interesting UEs, unicast/MBS traffic loading, UE locations, channel state information, etc.). If the UE gets the NR MBS configuration of serving NG-RAN node, it could receive the MBS data in RRC_CONNECTED accordingly. For UE power efficiency, it is beneficial to enable the MBS reception in RRC_INACTIVE. The NR MBS configuration used in RRC_INACTIVE state would be the same as used in RRC CONNECTED state or be a different configuration from RRC_CONNECTED state. If the configuration used in RRC_INACTIVE state is a separate configuration, the UE can receive a dedicated signaling (e.g., RRCRelease) with NR MBS configuration (e.g., including MBS session ID, G-RNTI, G-CS-RNTI, PTM/PTP configuration of MRB, the scheduling information of MTCH, DRX for MBS, HARQ configuration, etc.) for MBS data reception. The provided NR MBS configuration is optionally including the neighboring cell (e.g., suitable cell) information which the UE can directly apply for cell reselection. When transiting to RRC_INACTIVE state, the UE will keep monitoring an MBS indication, group notification and/or MBS related information (e.g., in system information, paging) for MBS reception. During cell reselection, the UE would like to select the same transmission manner/bearer configuration based on the stored NR MBS configuration since there may be the cases that the neighboring NG-RAN nodes share the same PTM configuration with the serving NG-RAN node via backhaul interface or Uu interface for MBS service continuity. Upon the reception of group notification (e.g., system information, paging) from the serving and neighboring cell(s), the UE would manually (re) select a new NG-RAN node based on the detection of new cell identifier, MBS session identifier (e.g., TMGI), and/or MBS indication. If a non-MBS-acceptable cell with an absent MBS indication is detected, the UE will try to camp on it. When a RACH procedure is triggered and a per-UE PDU session establishment is completed, the UE transits to the RRC_CONNECTED state for requesting MBS data (e.g., via NAS signaling, RRC signaling). The 5GCN/network could identify the UE is interested in the MBS session from the MBS context in the stored UE context. If the transparent MBS data request is accepted by 5GCN, the new NG-RAN node will receive a single copy of MBS data packets from 5GCN and deliver the separate copies of those MBS data packets to the UE via per-UE PDU session. A downlink control information (DCI) with the scheduling information of MBS data would be sent to the UE. Accordingly, the MBS data would be received by the UE via unicast manner.

FIG. 10 shows an MBS-enabled UE(s) manually reselects a new suitable cell between NG-RAN nodes with deactivated shared MBS delivery method according to a sixth embodiment of the present disclosure. A UE connects to a serving NG-RAN node to join at least one of MBS sessions. The serving NG-RAN node which is an MBS-acceptable cell would decide the MBS bearer transmission manner (i.e., PTM and/or PTP) based on the network condition (e.g., QoS requirement, number of serving/interesting UEs, unicast/MBS traffic loading, UE locations, channel state information, etc.). If the UE gets the NR MBS configuration of serving NG-RAN node, it could receive the MBS data in RRC_CONNECTED accordingly. For UE power efficiency, it is beneficial to enable the MBS reception in RRC_INACTIVE. The NR MBS configuration used in RRC_INACTIVE state would be the same as used in RRC_CONNECTED state or be a different configuration from RRC_CONNECTED state. If the configuration used in RRC_INACTIVE state is a separate configuration, the UE can receive a dedicated signaling (e.g., RRCRelease) with NR MBS configuration (e.g., including MBS session ID, G-RNTI, G-CS-RNTI, PTM/PTP configuration of MRB, the scheduling information of MTCH, DRX for MBS, HARQ configuration, etc.) for MBS data reception. The provided NR MBS configuration is optionally including the neighboring cell (e.g., suitable cell) information which the UE can directly apply for cell reselection. When transiting to RRC_INACTIVE state, the UE will keep monitoring an MBS indication, group notification and/or MBS related information (e.g., in system information, paging) for MBS reception. During cell reselection, the UE would like to select the same transmission manner/bearer configuration based on the stored NR MBS configuration since there may be the cases that the neighboring NG-RAN nodes share the same PTM configuration with the serving NG-RAN node via backhaul interface or Uu interface for MBS service continuity. Upon the reception of group notification (e.g., system information, paging) from the serving and neighboring cell(s), the UE would manually (re) select a new NG-RAN node based on the detection of new cell identifier, MBS session identifier (e.g., TMGI), and/or MBS indication. If an MBS indication indicating a deactivated suitable cell is detected, the UE can manually reselect the suitable cell and try to camp on it. An MBS data request (e.g., via 2/4-step RACH SDT, MBS tracking area update, RRC connection resume) is transmitted by the UE to request activating the MBS session. In this way, the new NG-RAN node would activate the MBS session because the 5GCN/network could identify the UE is interested in the MBS session from the MBS context in the stored UE context. If the MBS session is activated, the new NG-RAN node will receive the MBS data packets from 5GCN via the Shared MBS delivery method. In some cases, after the transmission of MBS data request, the UE can directly apply the associated stored configuration for monitoring the MBS information (e.g., NR MBS configuration, MBS paging notification) on the suitable cell. Then the MBS data can be received without UE state transition. Alternatively, a group notification (e.g., via paging) with the updated NR MBS configuration would be transmitted on the MBS paging occasion/RAN paging cycle. In other words, the 5GCN/network would send a group notification (e.g., via paging) to this MBS session area, including paging information (UE ID, UE DRX cycle, updated NR MBS configuration) of the determined list of UEs for the MBS session. Based on the updated NR MBS configuration, the UE could receive the MBS data in RRC_INACTIVE accordingly. In general, the manual cell reselection is based on UE's configuration and the associated MBS QOS requirement. The UE may choose the deactivated suitable cell if there is no activated suitable cell/MBS-acceptable cell detected.

FIG. 11 shows an MBS-enabled UE(s) manually reselects a new MBS-acceptable cell between NG-RAN nodes with deactivated shared MBS delivery method according to a seventh embodiment of the present disclosure. A UE connects to a serving NG-RAN node to join at least one of MBS sessions. The serving NG-RAN node which is an MBS-acceptable cell would decide the MBS bearer transmission manner (i.e., PTM and/or PTP) based on the network condition (e.g., QoS requirement, number of serving/interesting UEs, unicast/MBS traffic loading, UE locations, channel state information, etc.). If the UE gets the NR MBS configuration of serving NG-RAN node, it could receive the MBS data in RRC_CONNECTED accordingly. For UE power efficiency, it is beneficial to enable the MBS reception in RRC_INACTIVE. The NR MBS configuration used in RRC_INACTIVE state would be the same as used in RRC_CONNECTED state or be a different configuration from RRC_CONNECTED state. If the configuration used in RRC_INACTIVE state is a separate configuration, the UE can receive a dedicated signaling (e.g., RRCRelease) with NR MBS configuration (e.g., including MBS session ID, G-RNTI, G-CS-RNTI, PTM/PTP configuration of MRB, the scheduling information of MTCH, DRX for MBS, HARQ configuration, etc.) for MBS data reception. The provided NR MBS configuration is optionally including the neighboring cell (e.g., suitable cell) information which the UE can directly apply for cell reselection. When transiting to RRC_INACTIVE state, the UE will keep monitoring an MBS indication, group notification and/or MBS related information (e.g., in system information, paging) for MBS reception. During cell reselection, the UE would like to select the same transmission manner/bearer configuration based on the stored NR MBS configuration since there may be the cases that the neighboring NG-RAN nodes share the same PTM configuration with the serving NG-RAN node via backhaul interface or Uu interface for MBS service continuity. Upon the reception of group notification (e.g., system information, paging) from the serving and neighboring cell(s), the UE would manually (re) select a new NG-RAN node based on the detection of new cell identifier, MBS session identifier (e.g., TMGI), and/or MBS indication. If only an MBS indication indicating a deactivated MBS-acceptable cell is detected, the UE can manually reselect the MBS-acceptable cell and try to camp on it. A preconfigured MBS preamble/MBS system information (SI) request is transmitted by the UE to perform dedicated RACH/on-demand SI and to establish the associated MBS PDU session for activating the MBS session. In some cases, a RRC connection resume request is transmitted by the UE to resume the associated MBS PDU session for activation the MBS session. In some cases, an MBS data request (e.g., via 2/4-step RACH SDT, MBS tracking area update, RRC connection resume) is transmitted by the UE to require the associated MBS configuration if the stored MBS configuration is not available. The 5GCN/network could identify the UE is interested in which MBS session from the MBS context in the stored UE context. In this way, the UE will transit to the RRC_CONNECTED state for connecting with the new NG-RAN node. If the MBS session is activated and available, the new NG-RAN node will receive the MBS data packets from 5GCN via the Shared MBS delivery method. A new MBS configuration and the MBS data could be received accordingly. In general, the manual cell reselection is based on UE's configuration and the associated MBS QoS requirement. The UE may choose the deactivated MBS-acceptable cell if there is no activated MBS-acceptable cell detected.

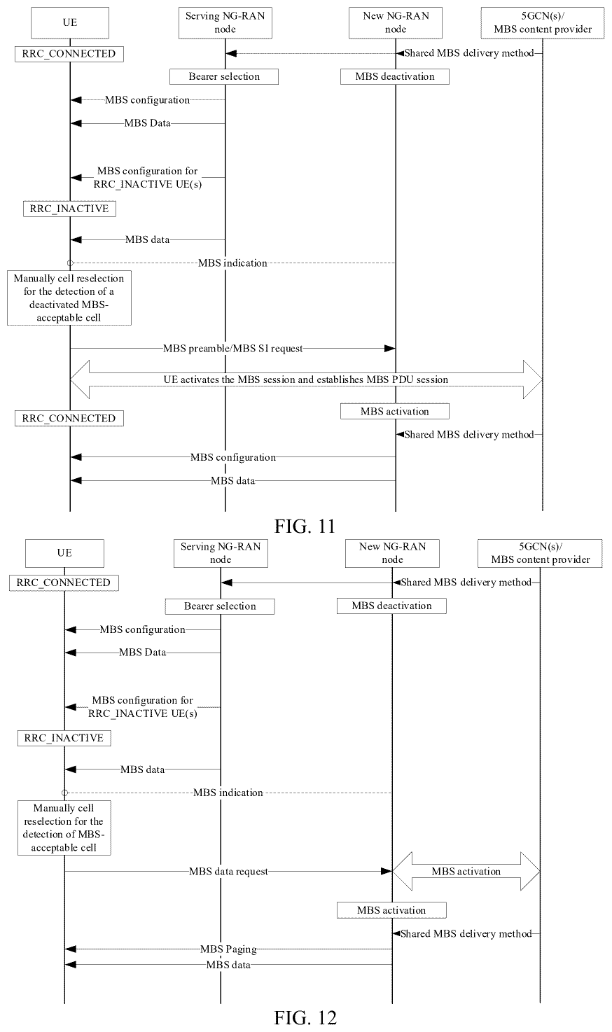

FIG. 12 shows an MBS-enabled UE(s) manually reselects a new MBS-acceptable cell between NG-RAN nodes with deactivated shared MBS delivery method in RRC_INACTIVE state according to an eighth embodiment of the present disclosure. A UE connects to a serving NG-RAN node to join at least one of MBS sessions. The serving NG-RAN node which is an MBS-acceptable cell would decide the MBS bearer transmission manner (i.e., PTM and/or PTP) based on the network condition (e.g., QoS requirement, number of serving/interesting UEs, unicast/MBS traffic loading, UE locations, channel state information, etc.). If the UE gets the NR MBS configuration of serving NG-RAN node, it could receive the MBS data in RRC_CONNECTED accordingly. For UE power efficiency, it is beneficial to enable the MBS reception in RRC_INACTIVE. The NR MBS configuration used in RRC_INACTIVE state would be the same as used in RRC_CONNECTED state or be a different configuration from RRC_CONNECTED state. If the configuration used in RRC_INACTIVE state is a separate configuration, the UE can receive a dedicated signaling (e.g., RRCRelease) with NR MBS configuration (e.g., including MBS session ID, G-RNTI, G-CS-RNTI, PTM/PTP configuration of MRB, the scheduling information of MTCH, DRX for MBS, HARQ configuration, etc.) for MBS data reception. The provided NR MBS configuration is optionally including the neighboring cell (e.g., suitable cell) information which the UE can directly apply for cell reselection. When transiting to RRC_INACTIVE state, the UE will keep monitoring an MBS indication, group notification and/or MBS related information (e.g., in system information, paging) for MBS reception. During cell reselection, the UE would like to select the same transmission manner/bearer configuration based on the stored NR MBS configuration since there may be the cases that the neighboring NG-RAN nodes share the same PTM configuration with the serving NG-RAN node via backhaul interface or Uu interface for MBS service continuity. Upon the reception of group notification (e.g., system information, paging) from the serving and neighboring cell(s), the UE would manually (re) select a new NG-RAN node based on the detection of new cell identifier, MBS session identifier (e.g., TMGI), and/or MBS indication. If only an MBS indication indicating a deactivated MBS-acceptable cell is detected, the UE can manually reselect the MBS-acceptable cell and try to camp on it. An MBS data request (e.g., via 2/4-step RACH SDT, MBS tracking area update, RRC connection resume) is transmitted by the UE to request the MBS session activation. The 5GCN/network could identify the UE is interested in which MBS session from the MBS context in the stored UE context. In this way, the new NG-RAN node would activate the MBS session based on the UE request, and negotiate with 5GCN, if necessary. If the MBS session is activated, the new NG-RAN node will receive the MBS data packets from 5GCN via the Shared MBS delivery method. Then a group notification with a new NR MBS configuration (e.g., via paging) would be transmitted on the MBS paging occasion/RAN paging cycle. In other words, the 5GCN/network would send a group notification (e.g., via paging) to this MBS session area, including paging information (UE ID, UE DRX cycle, new NR MBS configuration) of the determined list of UEs for the MBS session. The UE could receive the MBS data in RRC_INACTIVE accordingly. In general, the RRC_INACTIVE UE may choose the deactivated MBS-acceptable cell without state transition when there is no activated MBS-acceptable cell detected.

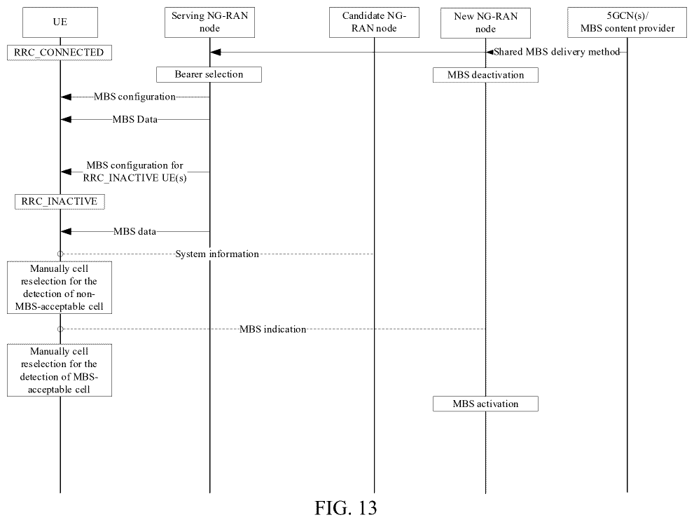

FIG. 13 shows an MBS-enabled UE(s) manually reselects a new MBS-acceptable cell between NG-RAN nodes with individual MBS delivery and deactivated shared MBS delivery methods according to a ninth embodiment of the present disclosure. A UE connects to a serving NG-RAN node to join at least one of MBS sessions. The serving NG-RAN node which is an MBS-acceptable cell would decide the MBS bearer transmission manner (i.e., PTM and/or PTP) based on the network condition (e.g., QoS requirement, number of serving/interesting UEs, unicast/MBS traffic loading, UE locations, channel state information, etc.). If the UE gets the NR MBS configuration of serving NG-RAN node, it could receive the MBS data in RRC_CONNECTED accordingly. For UE power efficiency, it is beneficial to enable the MBS reception in RRC_INACTIVE. The NR MBS configuration used in RRC_INACTIVE state would be the same as used in RRC_CONNECTED state or be a different configuration from RRC_CONNECTED state. If the configuration used in RRC_INACTIVE state is a separate configuration, the UE can receive a dedicated signaling (e.g., RRCRelease) with NR MBS configuration (e.g., including MBS session ID, G-RNTI, G-CS-RNTI, PTM/PTP configuration of MRB, the scheduling information of MTCH, DRX for MBS, HARQ configuration, etc.) for MBS data reception. The provided NR MBS configuration is optionally including the neighboring cell (e.g., suitable cell) information which the UE can directly apply for cell reselection. When transiting to RRC_INACTIVE state, the 5GCN could identify which UE is interested in the MBS session from the MBS context in the stored UE context. The UE will keep monitoring an MBS indication, group notification and/or MBS related information (e.g., in system information, paging) for MBS reception. During cell reselection, the UE would like to select the same transmission manner/bearer configuration based on the stored NR MBS configuration since there may be the cases that the neighboring NG-RAN nodes share the same PTM configuration with the serving NG-RAN node via backhaul interface or Uu interface for MBS service continuity. Upon the reception of group notification (e.g., system information, paging) from the serving and neighboring cell(s), the UE would manually (re) select a new NG-RAN node based on the detection of new cell identifier, MBS session identifier (e.g., TMGI), and/or MBS indication. If a non-MBS-acceptable cell with an absent MBS indication is detected, the UE would like to skip to camp on the candidate NG-RAN node and keep searching for a new NG-RAN node which is an MBS-acceptable cell. Upon the detection of a deactivated MBS-acceptable cell, the UE can manually reselect for camping on it. The operations of a deactivated MBS-acceptable cell reselection have been described in detail in the aforesaid sixth to eighth embodiments, and thus will not be repeated herein. In general, the UE may prefer to choose a suitable/MBS-acceptable cell other than a non-MBS-acceptable cell. A continuous MBS would be provided by an MBS-acceptable cell, which is triggered by the MBS-enabled UE.

FIG. 2B shows an MBS-enabled UE(s) manually reselects a new NG-RAN node which is a RAN functional split node according to a tenth embodiment of the present disclosure. The associated gNB-CU/gNB-DU F1AP identifier and parameters during NR MBS configuration/data/paging transmission would be used. The MBS cell reselection is performed as the aforesaid embodiments, wherein the RRC message proposed in this embodiment is encapsulated in the F1AP message(s) (e.g., UE Context Modification, DL/UL RRC Message Transfer, etc.) and will not be described again.

Commercial interests for some embodiments are as follows. 1. solving issues in the prior art. 2. better resource efficiency. 3. low lattency. 4. service ccontinuity. 5. providing a good communication performance. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

The embodiment of the present application further provides a user equipment includes a memory and a processor coupled to the memory, the processor configured to call and run program instructions stored in a memory, to execute the afore-described cell reselection method for MBS service continuity. The details on this method are referred to above content and are not repeated herein.

The embodiment of the present application further provides a network node (e.g., a base station) includes a memory and a processor coupled to the memory, the processor configured to call and run program instructions stored in a memory, to execute the afore-described method for providing MBS service continuity. The details on this method are referred to above content and are not repeated herein.

The embodiment of the present application further provides a computer readable storage medium for storing a computer program. The computer readable storage medium enables a computer to execute corresponding processes implemented by the UE/BS in each of the methods of the embodiment of the present disclosure. For brevity, details will not be described herein again.

The embodiment of the present application further provides a computer program product including computer program instructions. The computer program product enables a computer to execute corresponding processes implemented by the UE/BS in each of the methods of the embodiment of the present disclosure. For brevity, details will not be described herein again.

The embodiment of the present application further provides a computer program. The computer program enables a computer to execute corresponding processes implemented by the UE/BS in each of the methods of the embodiment of the present disclosure. For brevity, details will not be described herein again.

Although not shown in detail any of the devices or apparatus that form part of the network may include at least a processor, a storage unit and a communications interface, wherein the processor unit, storage unit, and communications interface are configured to perform the method of any aspect of the present invention. Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor including the computer system to cause the processor to perform specified operations. Such instructions, generally referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices.

Thus, the elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1-52. (canceled)

53. A cell reselection method for multicast and/or broadcast service (MBS) service continuity, performed by a power saving user equipment (UE) in a network, the method comprising:
staying on a first cell for MBS data reception based on an MBS configuration in a power saving state:
receiving a signaling from at least one of the first cell or at least one neighboring cell for the power saving UE to prioritize cells for cell reselection, wherein an MBS indication comprised in the signaling is configured to identify whether an MBS session of an associated cell is activated: and
selecting a second cell from the at least one neighboring cell based on the MBS indication, and changing from the first cell to the second cell to camp on for the MBS data reception.

54. The method of claim 53, wherein the MBS session of the associated cell is deactivated if the MBS indication is set to one value, and the MBS session of the associated cell is activated for MBS in the power saving state if the MBS indication is set to another value different from the one value.

55. The method of claim 53, wherein the MBS indication is further configured to identify at least one of a point-to-multipoint (PTM) transmission manner or a point-to-point (PTP) transmission manner supported by the associated cell to transmit MBS data.

56. The method of claim 55, wherein a neighboring cell which supports a transmission manner that is the same as the transmission manner the UE has been used is prioritized to be selected as the second cell.

57. The method of claim 56, further comprising:
receiving an indication to indicate whether the transmission manner used by the first cell to transmit MBS data is the same with the at least one neighboring cell.

58. The method of claim 53, wherein a neighboring cell which has a PTM configuration as the same as the first cell is prioritized to be selected as the second cell.

59. The method of claim 53, further comprising:
receiving an indication to indicate whether a PTM configuration used by the UE to receive MBS data from the first cell is the same with the at least one neighboring cell.

60. The method of claim 53, wherein based on a stored PTM configuration, the UE receives MBS data from the second cell without state transition.

61. The method of claim 53, wherein neighboring cell information which the UE can directly apply for cell reselection is included in the MBS configuration, and wherein all of suitable cells provided in stored neighboring cell information are cells that can provide MBS control and data channel to continue MBS data transmission via at least one of PTM or PTP transmission manner.

62. The method of claim 53, wherein the UE directly applies stored MBS configuration from the first cell for the MBS data reception when camping on the second cell.

63. The method of claim 53, wherein an MBS-acceptable cell is selected as the second cell on which the UE camps, and the MBS-acceptable cell is a cell providing MBS control and data channel to continue MBS data transmission via at least one of PTM or PTP transmission manner.

64. The method of claim 53, further comprising:
transmitting by the UE at least one of an MBS preamble or an MBS system information (SI) request to request joining an ongoing MBS session and to establish an associated MBS Packet Data Unit (PDU) session; or
transmitting by the UE an MBS data request via a random access (RA) procedure or an MBS tracking area update to request joining an ongoing MBS session.

65. The method of claim 53, wherein if the MBS indication indicating the associated cell with a deactivated MBS session is detected, the method further comprises:
transmitting by the UE at least one of an MBS preamble or an MBS system information (SI) request to activate the MBS session and to establish an associated MBS Packet Data Unit (PDU) session.

66. The method of claim 53, wherein the UE camps on a non-MBS-acceptable cell if only the non-MBS-acceptable cell is detected, and the non-MBS-acceptable cell is a cell providing MBS data via unicast manner upon the UE in a non-power saving state.

67. The method of claim 53, further comprising:
receiving a signaling from at least one of the first cell or the at least one neighboring cell for the power saving UE, wherein a notification comprised in the signaling is configured to notify the UE to receive MBS data without state transition.

68. The method of claim 67, wherein the signaling carries a paging message which includes the notification to indicate a stored PTM configuration is used to apply the reception of MBS data.

69. The method of claim 67, wherein the signaling carries a radio access network (RAN)-based paging message or a core network (CN)-based paging message which includes the notification to indicate an updated PTM configuration of a determined list of UEs for the MBS session.

70. A method for providing multicast and/or broadcast service (MBS) service continuity, performed by a network node in a network, the method comprising:
transmitting a signaling to a power saving user equipment (UE) for the UE to prioritize cells for cell reselection, wherein an MBS indication comprised in the signaling is configured to identify whether an MBS session of an associated cell is activated for the UE to decide whether to change from a serving cell to the associated cell to camp on for MBS data reception.

71. A user equipment (UE), comprising a memory and a processor coupled to the memory, the processor configured to call and run program instructions stored in a memory to execute the method of claim 53.

72. A network node, comprising a memory and a processor coupled to the memory, the processor configured to call and run program instructions stored in a memory to execute the method of claim 70.
